(19) United States
(12) Patent Application Publication
(10) Pub. No.: US 2014/0029727 A1
(43) Pub. Date: Jan. 30, 2014

(54) X-RAY GENERATING APPARATUS FOR PARACENTESIS

(71) Applicant: CANON KABUSHIKI KAISHA, Tokyo (JP)

(72) Inventor: Takeo Ono, Sagamihara-shi (JP)

(21) Appl. No.: 13/943,876

(22) Filed: Jul. 17, 2013

(30) Foreign Application Priority Data
Jul. 26, 2012 (JP) 2012-165360

(51) Int. Cl. H01J 35/16

(52) U.S. Cl. CPC H01J 35/16
USPC 378/121

(57) ABSTRACT

An X-ray generating apparatus for paracentesis of the present invention has an electron emitting portion arranged in an envelope, and a target that emits X-ray by irradiation with electrons that are emitted from the electron emitting portion, and irradiates an affected part in a living body with the X-ray which have been emitted from the target. The apparatus can adjust a region to be irradiated with X-ray, and thereby enables the affected part to be more effectively and efficiently treated with X-ray.

The apparatus also includes a front shield which is provided so as to protrude to the outside from the envelope and has an opening that forms a passage of the X-ray which irradiate the affected part, and can adjust a region to be irradiated with X-ray which irradiate the affected part, by the exchange of the front shield.

### BACKGROUND OF THE INVENTION

1. Field of the Invention

The present invention relates to an X-ray generating apparatus for paracentesis, which is used in a medical field or an industrial field.

2. Description of the Related Art

An X-ray generating apparatus is known for paracentesis to treat an affected part by irradiation with X-ray. Japanese Patent No. 3,090,910 discloses a reflection type of X-ray generating apparatus which mounts a cold cathode that is an electron emitting portion and a target provided in a thin envelope, and is configured so that an electric power for driving can be supplied through a coaxial cable which is connected to the rear end of the envelope. When the electric power is supplied, the cold cathode emits electrons, the electrons irradiate the target to generate X-ray, and the X-ray irradiates the affected part through a window portion which is provided on a lateral side of the head side of the envelope.

In addition, U.S. Pat. No. 7,382,857 discloses a transmission type of X-ray generating apparatus which has a thermionic cathode that is an electron emitting portion, so as to face a target, in a thin envelope of which the head is formed of the target, and has an optical fiber that is connected to the rear end of the envelope. When a laser beam irradiates the thermionic cathode through the optical fiber, electrons are emitted from the thermionic cathode, the electrons irradiate the target to generate X-ray, and the X-ray irradiates the affected part through the head portion of the envelope, which is formed of the target that serves as a window portion.

However, conventional X-ray generating apparatuses for paracentesis cannot adjust a region to be irradiated with X-ray, so as to match the size and the position of the affected part (cannot adjust size or position of region which X-ray irradiates). Because of this, a region to be irradiated with X-ray deviates from the size and the position of the affected part, and it is difficult to effectively and efficiently treat the affected part by optimal irradiation with X-ray.

The present invention is designed with respect to the above described conventional problems, and an object is to enable an X-ray generating apparatus for paracentesis to adjust a region to be irradiated with X-ray, and thereby to more effectively and efficiently treat the affected part with the X-ray.

### SUMMARY OF THE INVENTION

In order to achieve the object, the present invention provides an X-ray generating apparatus for paracentesis, which has an electron emitting portion arranged in an envelope, and a target that emits X-ray by irradiation with electrons that are emitted from the electron emitting portion, and irradiates a specific site with the X-ray which have been emitted from the target, includes a front shield which is arranged so as to protrude to the outside from the envelope, and has an opening that forms a passage of the X-ray which irradiate the specific site, wherein a region to be irradiated with X-ray on the specific site can be adjusted by the front shield.

Further features of the present invention will become apparent from the following description of exemplary embodiments with reference to the attached drawings.

### BRIEF DESCRIPTION OF THE DRAWINGS

FIG. 1 is a cross-sectional view schematically illustrating a first embodiment of the present invention.

FIG. 2 is an enlarged cross-sectional view of a target.

FIG. 3 is an enlarged cross-sectional view of a periphery of the target.

FIG. 4 is a schematic view illustrating another example of a front shield.

FIG. 5A and FIG. 5B are schematic views illustrating further another example of the front shield; and FIG. 5A is a cross-sectional view, and FIG. 5B is a front view of a head side.

FIG. 6 is an explanatory view of the photon energy dependency of a mass absorption coefficient of X-ray.

FIG. 7 is an explanatory view of Exemplary Embodiment 3.

FIG. 8 is an explanatory view of Exemplary Embodiment 4.

### DESCRIPTION OF THE EMBODIMENTS

Embodiments of the present invention will be described below with reference to drawings. For information, in the following drawings which are referred to, the same reference numeral represents a similar component.

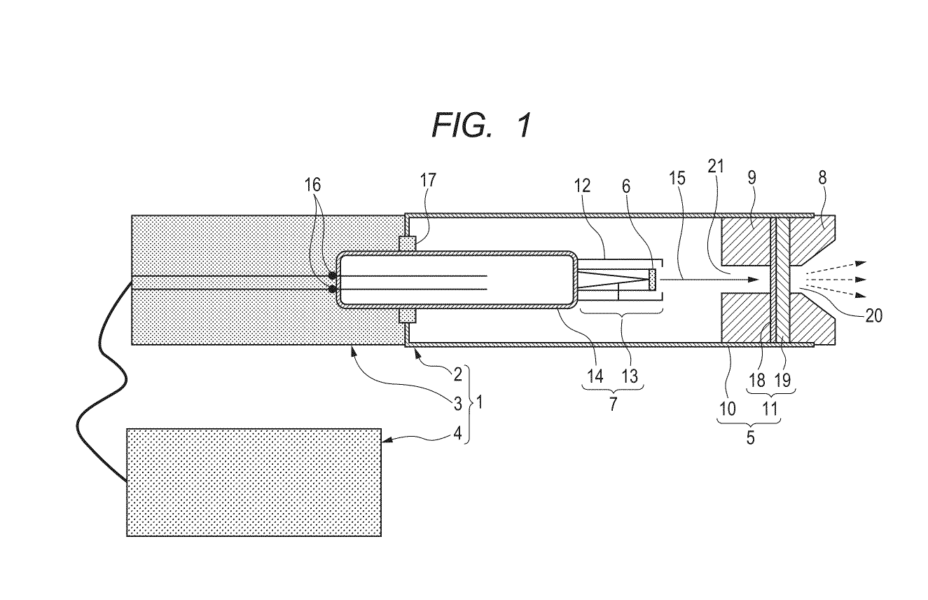

FIG. 1 is a schematic view illustrating a structure of a first embodiment of the present invention.

An X-ray generating apparatus 1 for paracentesis includes an X-ray tube 2, a grip portion 3, and a control section 4.

The X-ray tube 2 functions as an emission source of X-ray, and includes: an envelope 5; an electron gun 7 which has an electron emitting portion 6; a front shield 8; and a rear shield 9.

The envelope 5 includes a cylindrical drum portion 10 and a target 11 which is formed so as to block one end side (head side) of this drum portion 10. The target 11 is a transmission type; and generates X-ray in a side opposite to the side which is irradiated with an electron beam, and serves as a window portion for taking out the generated X-ray therethrough. The inner part of the envelope 5 is decompressed (evacuated). The degree of vacuum in the inner part of the envelope 5 have only to be a degree of vacuum in which an electron can fly a distance between the electron emitting portion 6 of the electron gun 7 and the target 11, as a mean free path of the electron, and a degree of vacuum of 1×10⁻⁴ Pa or less can be applied. In order to maintain the degree of vacuum in the envelope 5, an unillustrated getter can also be set in a space in the envelope 5 or in an auxiliary space which communicates with this space. In order to facilitate an electric connection which specifies a potential in the target 11 side to be taken from the grip portion 3 side, a material of the drum portion 10 which constitutes the envelope 5 can preferably be an electroconductive material, and usually is formed of metal. In addition, in order to be simultaneously capable of shielding X-ray and preventing an excessive exposure to radiation, the material can preferably be formed of a metal which has a high shielding effect for X-ray, for instance, a heavy metal such as molybdenum, tantalum and tungsten, and specifically can preferably be formed of a metal having the atomic number of 30 or more. A rear end portion of the drum portion 10 is connected to an earth terminal, and thereby the envelope 5 can preferably be set at the ground potential.

The electron gun 7 includes: an electron-beam accelerating portion (hereafter, accelerating portion) 13 having the electron emitting portion 6 and a control electrode 12 provided therein; and a flange portion 14. The electron gun 7 is inserted into the rear end side of the envelope 5 from the accelerating portion 13 side, and the electron emitting portion 6 which is provided in the accelerating portion 13 is arranged in the inner part of the envelope 5 so as to oppose to the target 11. The accelerating portion 13 makes the electron emitting portion 6 emit electrons, makes the control electrode 12 shape the electrons emitted from the electron emitting portion 6 into an electron beam 15 having a desired trajectory and a desired size, and projects the electron beam towards the target 11. The electron gun 7 can be an electron gun which can control the amount of the electrons to be emitted, from the outside of the envelope 5. In addition, the electron emitting portion 6 may be an electron emitting portion which uses a cold cathode, but can preferably be an electron emitting portion using a thermionic cathode which provides a stable electric current. The desirable electron emitting portion 6 can include: a filament type cathode that is formed from a high melting point metal such as tungsten and rhenium, or is formed from the high melting point metal on the surface of which yttria or the like is applied; a thermal field-emission type cathode: and an impregnation type cathode that is formed from barium oxide as a main component, which is impregnated with porous tungsten.

The accelerating portion 13 is electrically connected to the control section 4, through a vacuum and airtight introduction terminal 16 which is provided in a rear end portion of the flange portion 14 that protrudes into the grip portion 3 from the rear end of the envelope 5. An electric power and an electric signal for driving accelerating portion 13 are supplied from the control section 4 which is provided in the outside of the envelope 5, through a wire passing in the grip portion 3 that serves as one part of a connecting cable.

When the accelerating portion 13 is driven, electrons are emitted from the electron emitting portion 6, and the electrons are shaped into the electron beam 15 having the energy of approximately 10 key to 60 key, by an unillustrated extraction grid and an unillustrated accelerating electrode. When this electron beam 15 is incident on the target 11, X-ray is emitted. The extraction grid and the accelerating electrode may be separately provided along a trajectory of the electron beam 15 in the envelope 5, but can be housed in the accelerating portion 13. In addition, it is also possible to provide a correction electrode for adjusting a position of a spot to be irradiated with the electron beam 15 and astigmatism, connect the correction electrode to an unillustrated correction circuit, and adjust the position of the spot to be irradiated with the electron beam 15 and the astigmatism. The correction electrode may be provided along the trajectory of the electron beam 15 in the envelope 5 separately from the electron gun 7, but can also be housed in the accelerating portion 13. In addition, the correction circuit can be provided in any of the inner part of the envelope 5 and in the outside thereof, as long as the correction circuit can be controlled from the outside of the envelope 5.

The flange portion 14 is connected to the drum portion 10 of the envelope 5 through an insulator 17. A brazing technique can be used for connecting the flange portion 14 with the insulator 17, and connecting the insulator 17 with the drum portion 10. Materials of the insulator 17, the flange portion 14 and the drum portion 10 can preferably be a material which can be easily brazed, and when the insulator 17 is alumina, for instance, the flange portion 14 and the drum portion 10 are optimally formed from Kovar. By connecting the flange portion 14 of the electron gun 7 and the drum portion 10 of the envelope 5 to each other while sandwiching the insulator 17 between them, the X-ray generating apparatus seals the inner space of the envelope 5 and simultaneously electrically insulates between the flange portion 14 and the drum portion 10.

The grip portion 3 is provided in the other end side (rear end side) of the drum portion 10. The grip portion 3 is used for determining a position after puncture, can have such a structure having rigidity as to be capable of being controlled from the outside, and also can have a structure functioning also as a cable by providing a through-hole therein in which a wire for supplying an electric power passes therethrough. The grip portion 3 is structured so that a coaxial internal conductor having flexibility is covered, for instance, with a stacked body of a reticulated support dielectric also having flexibility, and thereby can be structured so as to acquire such rigidity as to be capable of controlling the position when the X-ray generating apparatus has been inserted into the body, and so as to maintain withstand voltage. Furthermore, it is also possible to control a temperature rise occurring when the X-ray has been emitted, by liquid-tightly covering the outermost surface of the above described stacked body of the reticulated support dielectric, and providing a mechanism which circulates an insulating oil in the inner space formed of the reticulation.

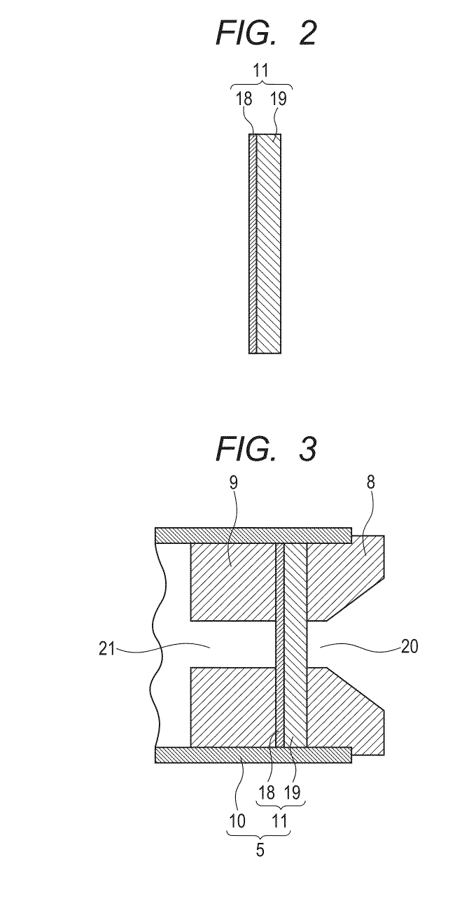

Next, a structure of the target 11 and the periphery of the target will be described with reference to FIG. 1 to FIG. 3. The target 11 constitutes one part of the envelope 5 of which the inner part is a vacuum atmosphere, and is arranged at a position at which the electron beam 15 emitted from the electron emitting portion 6 can be incident its inner face. The target 11 includes a target layer 18 and a substrate 19 which supports the target layer 18. The target layer 18 forms an inner face on which the electron beam 15 is incident, and is formed from a target substance which generates X-ray by the incidence of the electron beam 15. In the target substance, X-ray is generated in a process in which an electron in the incident electron beam 15 loses kinetic energy. Specifically, a region in a target substance, which is expressed by (electron penetration length)×(electron beam spot), becomes an X-ray generating region, and X-ray is radiated to all directions from the region. The target is a transmission type, and X-ray to be used among generated X-ray is the X-ray which transmits the substrate 19 and is emitted from the outer face side of the target 11. The X-ray which is emitted from the outer face side of the target 11 are shown by the arrows of the dashed lines in FIG. 1.

A diamond substrate, for instance, can be used as the substrate 19. In addition, the target layer 18 can be formed of a layer containing a metal of which the atomic number is 42 or more. The substrate 19 has the target layer 18 on the inner face in an inside direction of the envelope 5, and the outer face in the opposite side is an X-ray emitting face. In addition, a peripheral side face of the substrate 19 is a face bonded with the drum portion 10. In order to uniformize the transmissivity distribution of X-ray, the thickness of the substrate 19 can preferably be substantially uniform. The shape of the substrate 19 can be a cylindrical shape (discal shape) or a flat shape. When the diamond substrate is used, the upper limit of the thickness can be determined from the viewpoint of the transmissivity of the X-ray, the lower limit of the thickness can be determined from the viewpoint of heat transference and strength, and it is possible to use the substrate with the thickness in a range of 50 μm to 2,000 μm. The thickness can preferably be particularly in a range of 350 μm to 1,200 μm. The material of the diamond substrate may be any one of a single crystal, a polycrystal and an amorphous substance such as diamond-like carbon (DLC), but can preferably be a single crystal from the view point of thermal conductance. A process for obtaining the diamond substrate can be any of a chemical vapor deposition method (CVD), a sintered-body forming method and a high-pressure synthetic method which is a process of synthesizing the diamond under a high pressure by using a seed crystal, source carbon and a catalyst metal; and is not limited in particular. However, a high-pressure synthetic method can preferably be applied, from the view point of the securement of the thickness, the thermophysical properties and the purity.

As a target substance which constitutes the target layer 18, a metal having high specific gravity is used in order to efficiently convert an incident electron into X-ray. Specifically, the metal can preferably have the atomic number of 42 or more. For instance, tungsten, ruthenium, platinum, iridium, tantalum and the like can be applied. A region which is involved in the conversion from the electron to the X-ray is also a region which generates heat, at the same time. Accordingly, a local exothermic spot is produced in a range of the electron penetration length in a layer thickness direction of the target layer 18. When the target layer 18 is made from a material having high thermal conductance, heat is advantageously transferred from an exothermic portion to a peripheral member (front shield 8, rear shield 9 and the like) of which the temperature is lower than that of the exothermic portion, and accordingly the target layer can alleviate the overheating due to irradiation with the electron beam 15. Particularly, tungsten is a material which has a high melting point of 3,380° C. and a high heat conductivity of larger than 100 W/mK in a wide temperature range, and is one of more desirable materials.

The film thickness of the target layer 18 can be selected from the viewpoint of the amount of X-ray to be generated, an X-ray attenuation, the quality of X-ray, voltage for accelerating electrons, and heat transference to the peripheral member, and the practicable film thickness is in a range of 1 μm to 15 μm, for instance. When electrons which have been accelerated with higher voltage are used, the target layer 18 can have a higher film thickness than the electron penetration length. However, when it is desired that a characteristic radiation component is dominant than a bremsstrahlung radiation component, the target layer 18 can have a lower film thickness than the electron penetration length. Methods of sputtering, CVD and vapor deposition can be used as a method for forming the target layer 18.

For information, the arrangement of the target layer 18 with respect to the substrate 19 is not limited to a form in which the target layer covers the whole one face of the substrate 19, as illustrated in FIG. 3. The target layer 18 can also be formed so as to cover one part of the one face of the substrate 19. What type of form should be employed can be determined in consideration of a range to be irradiated with the electron beam 15 and an electrical connection with the peripheral member.

The target 11 is held in the head side of the envelope 5, in a state of being sandwiched between the front shield 8 and the rear shield 9. Specifically, the target is inserted in the head side of the drum portion 10, in order of the rear shield 9, the target 11 and the front shield 8. The target 11 can be fixed to the rear shield 9 and/or the drum portion. For fixing the target 11, any method can be used among a method using an electroconductive connection member such as silver solder material, a pressure bonding method and the like.

The front shield 8 is inserted in a head portion of the drum portion 10 while the rear end portion is detachably attached, and is arranged so as to protrude from the envelope 5 to the outside. This front shield 8 is provided with an opening 20 which is used as a passage of the X-ray that shall irradiate the affected part in a living body. The rear shield 9 is arranged in a position at which the rear shield faces the front shield 8 while sandwiching the target 11. This rear shield 9 has an electron incidence hole 21 which continues to the target 11 and passes the electron beam 15 therein. In the present example, the center of the electron emitting portion 6, the center of the electron incidence hole 21, the center of the target 11 and the center of the opening 20 are arranged so as to be aligned on a straight line.

While the front shield 8 and the rear shield 9 are shields for shielding X-ray to be unnecessarily emitted, and at the same time, are also members for holding the target 11 therebetween. In addition, the shields also serve as electric connection members for specifying the potential of the target layer 18 in the target 11 to a predetermined potential, so as to make the accelerated electron beam 15 incident on the target 11. Accordingly, these shields can preferably be made from a material that has heat resistance due to which the target 11 can be stably held at the predetermined position even when the temperature of the target 11 has varied, has an electroconductivity due to which the electric connection can be maintained, and besides, has a high shielding effect for X-ray. Specifically, metals, for instance, such as molybdenum, tantalum and tungsten, in other words, metals (heavy metal) having the atomic number of 30 or more, can be employed.

When the rear shield 9 is formed from a heavy metal, the rear shield 9 can limit radiation ranges of a reflected electron which is generated in the target 11 and X-ray which is radiated to the electron emitting portion 6 side. However, when the drum portion 10 is formed from a heavy metal, the rear shield 9 can be eliminated, or the rear shield 9 can be formed from a metal having a low shielding effect for X-ray, but the total weight tends to easily increase.

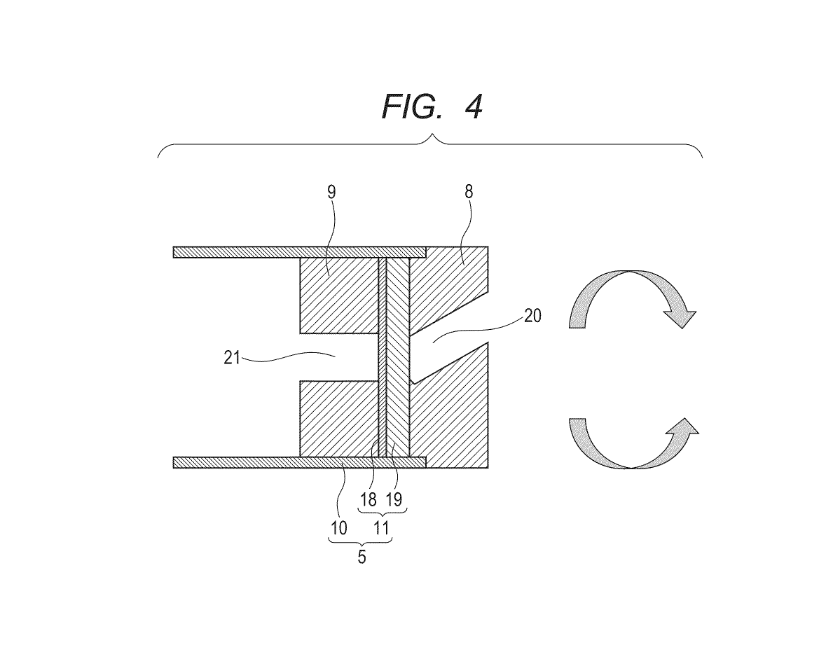

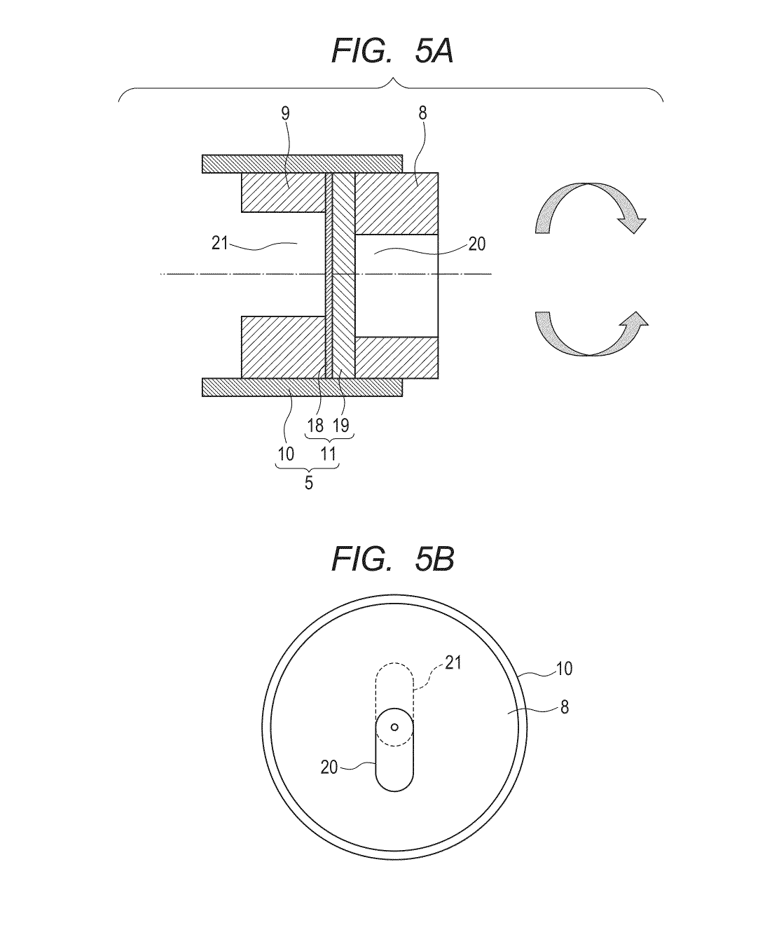

The front shield 8 is formed from a heavy metal, and limits the radiation range of X-ray which is emitted from the target 11 according to a diameter, a shape, a direction and the like of the opening 20, and thereby adjusts a region to be irradiated with X-ray. The front shield 8 is exchangeable. Accordingly, it is possible to minimize the influence on the normal tissue by preparing a plurality of the front shields 8 having the openings 20 of different diameters, shapes, directions and the like, and selecting a suitable shield according to the size and the location of the affected part. It is also possible to change the diameter or the shape of the opening 20 by shaping the opening 20 into a shape having such a taper as to expand toward the outside, and changing the angle of the taper. It is also possible to shape the opening 20 not only into a circle, but also an ellipse or the like. It is possible to control the direction of irradiation of X-ray to a diagonal direction, by forming the opening 20 so as to face diagonally with respect to the direction of irradiation of the electron beam 15 (axial direction of envelope 5) as is illustrated in FIG. 4. It is possible to change the direction of irradiation of X-ray by the rotation of the front shielding member 8, by structuring the front shield 8 so as to be rotatable around a rotation axis which is a central axis parallel to the direction of irradiation of the electron beam 15, and providing the opening 20 so as to incline with respect to the rotation axis. In addition, when the opening 20 and the electron-beam introduction hole 21 of the rear shield 9 are each formed in an ellipse so that one end part overlaps with one end part of the other as illustrated in FIG. 5A and FIG. 5B, it is also possible to overlap the whole of the ellipses by rotating the front shielding member 8 from this state. Specifically, it is also possible to adjust a region to be irradiated with X-ray by changing the state between the states in which the ellipses partially overlap and the ellipses wholly overlap. Furthermore, it is also possible to provide an unillustrated iris mechanism which can adjust the aperture diameter of the opening 20 according to the necessary region to be irradiated with X-ray, in the front shield 8, and adjust the region to be irradiated with X-ray by this iris mechanism. As the iris mechanism, the mechanism can be employed in which two sheet materials each having a notch or a hole are overlapped so that the notches or the holes overlap with each other and the sheet materials can slide on each other, for instance. In this case, the aperture of the opening 20 is formed by the overlapping part of the notches or the holes, and a size of this aperture can be adjusted by making two sheet materials slide on each other. In addition, the mechanisms can also be employed in which a plurality of sheet materials are slidably overlapped while the positions are being displaced so that the aperture can be formed by being surrounded by the sheet materials, and in which the structure is similar to the shutter of a camera.

A relation between potentials of the electron gun 7 and the target layer 18 can be appropriately selected according to the potential of the envelope 5, a type of the control section 4, and the like. For instance, it is also possible to ground an accelerating electrode of the accelerating portion 13, and besides specify the electron emitting portion (cathode) 6 at a negative potential with respect to the ground potential, and it is also possible to ground an arbitrary potential between the electron emitting portion 6 and the accelerating electrode, and specify the accelerating electrode at a positive potential and the potential of the electron emitting portion 6 at a negative potential.

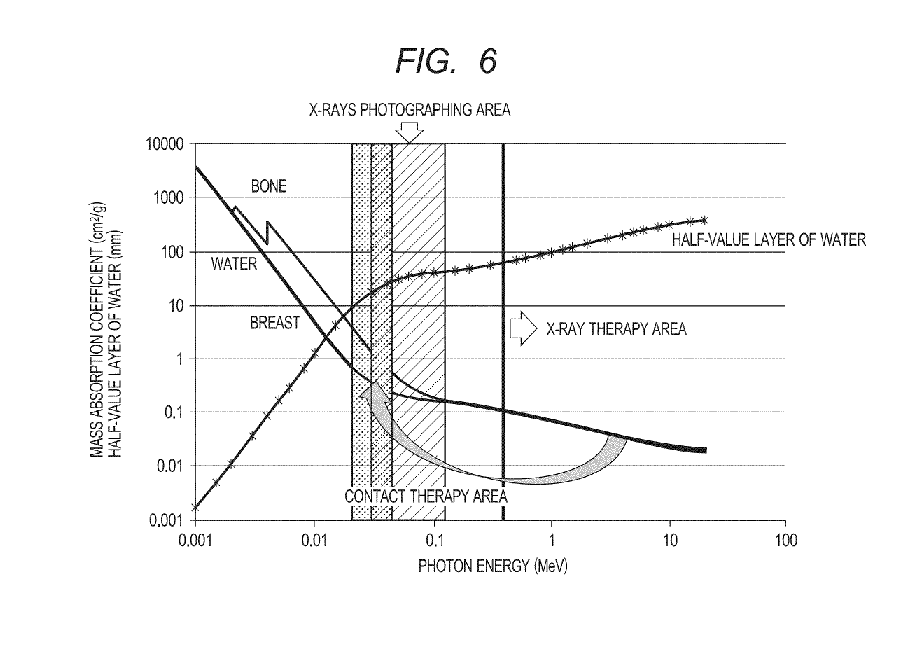

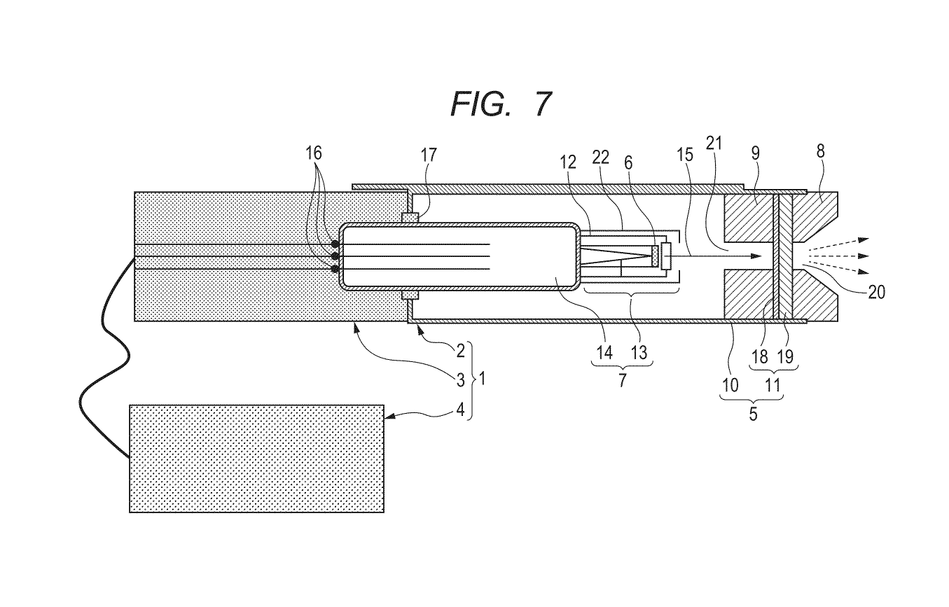

FIG. 6 illustrates the dependency of the mass absorption coefficient of X-ray for the water which is a main constitutive substance in a living body, the bone and the breast tissue, on photon energy (data of National Institute of Standards and Technology (NIST)). The absorbed energy emits an electron by ionization, and this electron damages DNA to result in killing a cancer cell. FIG. 6 also illustrates the thickness of a half-value layer by which photon energy is reduced to a half due to water. When X-ray for treatment irradiate the affected part in the living body from the outside, the half-value layer of 100 mm or thicker is needed so that the X-ray reaches the affected part sufficiently. Because of this, the X-ray using an energy region of 1 MeV or more is used for the treatment. As a result, the absorption coefficient decreases, accordingly an exposure dose increases, and a burden to a normal cell also increases.

Here, if the X-ray has energy of 0.01 MeV to 0.04 MeV, the absorption coefficient increases by one digit, and the exposure dose can be reduced. Furthermore, the half-value layer can also become the order of a few mm to tens of mm. Thereby the irradiation can be concentrated on the affected part, and a burden to the normal cell can be greatly reduced. The X-ray directly irradiates the cancer cell without passing through the normal cell, and it is thereby expected that the therapeutic effect remarkably increases.

In a reflection type of X-ray source, the X-ray results in passing through a long distance in the target, and the X-ray shows such characteristics that as the X-ray has lower energy with a larger absorption coefficient, the dose decreases. For this reason, the reflection type of X-ray source has inconvenient characteristics for obtaining X-ray of 0.01 MeV to 0.04 MeV. The reflection type target can also be used in the present invention, but a transmission type target can be used for the above described reason. In the case where the transmission type target is used, the dosage of the X-ray which is converted per unit accelerating current increases when the accelerating voltage is a certain value or more, and the electric current for generating the same dose can be reduced.

In the present invention, the voltage which accelerates the electron beam can be set at 60 kV or less, an energy peak of the X-ray which is taken out from the target can be set at 40 keV or less, and further can be set at 30 keV or less. Thereby the absorption coefficient of the X-ray can be increased. When the X-ray having low energy of 30 keV or less is used, the absorption coefficient in the body becomes one digit or more higher than the time when the X-ray having energy of 1 MeV or more is used, which are used for treatment by irradiation from the outside, and it is expected that the dose necessary for the treatment becomes smaller by one digit. Because the electric current necessary for generating the X-ray becomes one-tenth or less by including the above described increase of conversion efficiency, the X-ray generating apparatus can reduce an area of the electron emitting portion and a focal diameter in which the target is irradiated, and can miniaturize the X-ray source to a diameter of 10 mm or less which enables paracentesis, even if a cooling mechanism is added thereto.

It is also possible to arrange the envelope in the inner part of a storage container while preparing a space in the perimeter, and fill the inner space of the storage container with an insulating oil as a coolant. In this case, as described above, a space can be formed in the inner part of the grip portion, the space around the envelope in the inner part of the storage container and the space in the inner part of the grip portion can be communicated with each other, and the whole can be easily cooled. When the X-ray generating apparatus is structured in this way, the temperature of the whole can be easily kept low even when the X-ray generating apparatus has been driven with a high power. In addition, the outer surface of the envelope can be covered with a heat-resistant insulating material such as tetrafluoroethylene, for instance.

### EXAMPLES

### Example 1

An X-ray generating apparatus 1 for paracentesis was manufactured, which was illustrated in FIG. 1 to FIG. 3.

Specifically, firstly, a diamond substrate was prepared as a substrate 19, which was produced by high-pressure synthesis made by Sumitomo Electric Industries, Ltd. The substrate has a discal shape (cylindrical shape) having a diameter of 5 mm and a thickness of 1 mm, and has a thermal conductivity of 2,000 W/m/K at room temperature. An organic substance depositing on the surface of the substrate was removed beforehand by a UV-ozone asher.

A target layer 18 made from tungsten was formed on one face of this substrate 19 by sputtering with the use of Ar as a carrier gas, so as to have a thickness of 7 μm. When the tungsten film was formed, the substrate 19 was heated to 260° C. on a stage. The thermal conductivity of each layer was evaluated by a monitor substrate which was previously prepared in a film-forming process, and as a result, the thermal conductivity of the target layer 18 was 178 W/mK.

As for the thickness of the target layer 18, before the target layer was film-formed, calibration curve data between a film thickness of a film which was formed into a single layer film and a film formation period of time was obtained beforehand, and then the target layer 18 was formed so as to have a specified film thickness by the film formation period of time. A spectrum ellipsometer “UVISEL ER” made by HORIBA, Ltd. was used for measuring the film thickness for obtaining the calibration curve data.

A cross-section specimen was prepared so that the cross section of the obtained target 11 included the interface of the target layer 18 and the substrate 19, by mechanical polishing and focus ion beam machining (FIB machining). The prepared specimen was subjected to the mapping of a distribution state of a composition and a bond by an X-ray photoelectron spectroscopy (XPS). As a result, it has been confirmed that the regions exist in which tungsten that is a material of the target layer 18 is dominant, and in which carbon of diamond that is a material of the substrate 19 is dominant.

The target 11 was sandwiched between a rear shield 9 and a front shield 8. Here, the lengths (thickness) of the rear shield 9 and the front shield 8 in a central axis direction were each set at 5 mm, and an electron incidence hole 21 and an opening 20 were worked so as to be concentric circle shapes. Furthermore, the target layer 18 was fixed so as to come into contact with the rear shield 9 by using unillustrated silver solder as a connection layer, as illustrated in FIG. 3.

An electron gun 7 was arranged in the center of a drum portion 10 made from stainless steel with an outer diameter of 10 mm, and was structured so that the distance between the inner wall of the drum portion 10 and a control electrode 12 made from stainless steel was 3.2 mm or more. The position of a target unit (target 11, rear shield 9 and front shield 8) was adjusted so that a distance between the end of the target unit and the end of the control electrode 12 was approximately 5 mm, and the target unit was fixed. The rear shield 9 was fixed at the head side of the drum portion 10 by laser welding, and was structured so as to have vacuum sealing properties as well. The target layer 18 was connected to the drum portion 10 so that electrical conduction could be obtained between the drum portion 10 and the target layer 18 through the rear shield 9. The front shield 8 was detachably attached by being inserted into the head portion of the drum portion 10. The potential of the drum portion 10 was set at the ground potential through a connected earth terminal. The potential of the electron emitting portion 6 was set at −60 kV by an unillustrated power supply circuit, and the electron emitting portion was enabled to irradiate the center of the target layer 18 with an electron beam 15 which had the kinetic energy of 60 keV.

The above described X-ray generating apparatus for paracentesis was driven, and the dose was measured by using a dosimeter formed of a semiconductor detector. The dose was 1.7 R at a position 1 m apart from the apparatus, when the position was exposed for 1 second at 1 mA. When the obtained dose was converted into an absorbed dose, the absorbed dose was 15 mGy. This value was estimated to be 150 Gy when the distance was shortened to 10 mm, and it was confirmed that a sufficiently large quantity of the absorbed dose was generated by a low current. The electrons were emitted on such conditions that the focus was aligned on the surface of the target layer 18 and the spot radius of the electron beam 15 was controlled to 2 mm or less.

The temperature of a portion on the target 11, which was irradiated with the electron beam 15, rose to 75° C., but the temperatures of the front shield 8, the rear shield 9 and the head portion of the drum portion 10 which came into contact with the target 11 rose to 20° C. or lower, and the temperature was controlled to such a degree as not to give influence on the body even though the body was punctured with the head portion. In addition, when a plurality of front shields 8, 8 and so on are prepared, which have different sizes, shapes or directions of the opening 20, a region to be irradiated with the X-ray can be easily adjusted according to the size of the affected part which is a specific site, by the exchange of the front shields 8, 8 and so on.

Furthermore, the X-ray generating apparatus has a diagonal opening 20 as illustrated in FIG. 4 and the rotatable front shield 8, and thereby can also adjust a region to be irradiated by the rotation of the front shield 8.

### Example 2

A mechanism in which an insulating oil transferred heat was provided so as to come into contact with an envelope 5 illustrated in FIG. 1. The structures of the envelope 5 and the inner part thereof are similar to those in Example 1. A mechanism was also provided so as to inject and discharge the insulating oil for cooling from the middle of a grip portion 3 through an unillustrated temperature control device. The grip portion 3 was structured so that the coaxial internal conductor was covered with a stacked body of a reticulated flexible silicon resin, and a mechanism was provided in which the insulating oil circulated in the mesh of the reticulated flexible silicon resin. Thereby a temperature rise could be controlled which occurred when the X-ray were emitted.

The insulating oil was brought into contact with an introduction terminal 16, the rear portion of a flange portion 14, and the rear end portion of the envelope 5 and circulated between the portions and the temperature control device. Thereby, the temperature rise occurring when the inside of the body was exposed to the X-ray could be decreased to 10° C. or lower and a burden to a patient occurring when it was assumed that the inside of the body was irradiated with the X-ray could be further reduced. In addition, even when the dose is increased by increasing an electric current, a permissible range increases by the temperature control of the insulating oil, and accordingly, it is expected that a range of application in treatment is expanded.

### Example 3

The X-ray generating apparatus for paracentesis was structured similarly to that in Example 1, except that an electrode 22 was further added to the outside of a control electrode 12 in an accelerating portion 13, as illustrated in FIG. 7. The potential of the control electrode 12 was appropriately controlled, and thereby the diameter of an electron beam 15 which was converged on the target layer 18 could be controlled to 1 mm or smaller. In addition, an X-ray sensor was provided in the outside of the body, and thereby the arrangement of the periphery of the affected part which was irradiated with the X-ray in the body could be accurately detected through a transmission image.

### Example 4

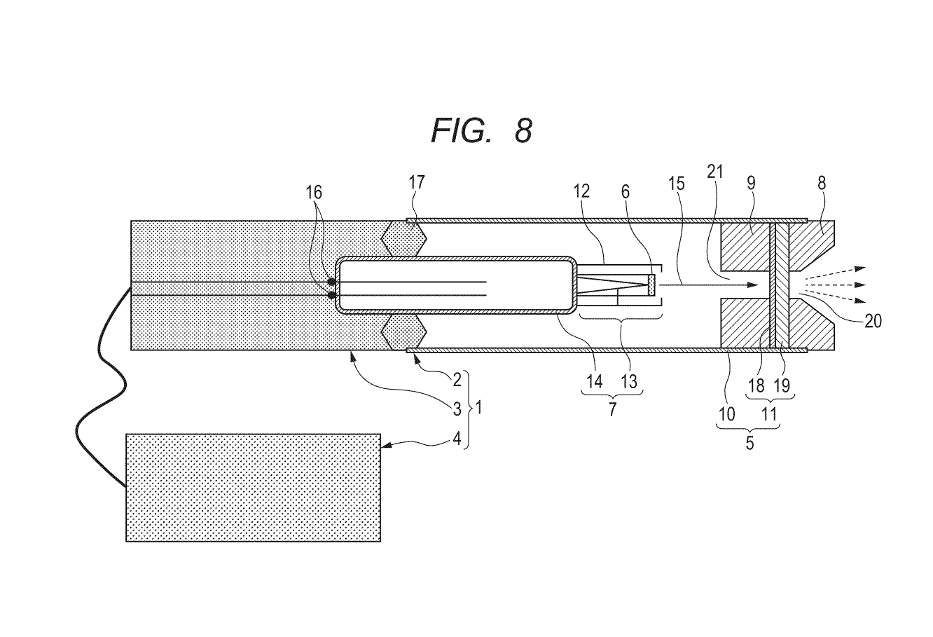

The X-ray generating apparatus for paracentesis was structured similarly to that in Example 1, except that an uneven shape was provided on an insulator 17 made from the ceramic which insulated between a drum portion 10 made from stainless steel and a flange portion 14 made from Kovar, as illustrated in FIG. 8.

Unevenness was provided on the side face of the insulator 17, on which a strong electric field was generated, in a direction perpendicular to an electric flux line of this electric field. A machining process or an etching process may be adopted for forming the unevenness. In the present example, a blasting operation by alumina beads was performed. A difference between the peak and the valley was controlled to 30 μm or more, thereby an electric discharge due to an avalanche phenomenon of unnecessary electrons was suppressed, and the withstand voltage was enhanced. The frequency of the electric discharges occurring on an insulator 17 portion was measured, and as a result, the withstand voltage because of which the electric discharge did not occur for 1 hour increased from 60 kV to 90 kV.

Due to the above described effect, X-ray having comparatively high energy with a low absorption coefficient can also be used, and accordingly, it is expected that a range of application expands also to such a cancer tissue as to have a wide range to be treated.

### Example 5

The X-ray generating apparatus for paracentesis was structured similarly to that in Example 1, except that the drum portion 10 of an envelope 5 and a control electrode 12 of an accelerating portion 13 were formed of tungsten having a thickness of 0.5 mm.

In Example 1, X-ray is isotropically emitted which are generated by bremsstrahlung radiation caused by the electron beam 15 that has been incident on the target 11, and most of the X-ray is shielded by the front shield 8 and the rear shield 9. The X-ray generating apparatus is structured so that the X-ray radiateds to an electron emitting portion 6 side cannot be shielded by the rear shield 9 and is shielded by an electron gun 7, but when an X-ray radiation dose has increased, a part of the X-ray may be scattered on a periphery. Then, the control electrode of the accelerating portion 13 shall be formed from tungsten having a thickness of 0.5 mm to increase a shielding effect for X-ray, and thereby, the dosage of the leaking X-ray can be reduced to such a value as not to cause a problem. Furthermore, when the electron beam 15 has been deviated by impact or the like, the rear shield 9 may be irradiated with the electron beam, and the dosage of the leaking X-ray to the periphery may increase. In the case of the present example, tungsten having an excellent shielding effect is used for the envelope 5 to cope with the risk, accordingly the amount of leakage can be reduced, and the reliability can be enhanced.

In the above description, the cases have been described where the present invention has been applied to medical use. However, the present invention is not limited to the medical use, but can be applied also to industrial use for irradiating a specific site other than the affected part with the X-ray.

The X-ray generating apparatus for paracentesis according to the present invention includes a front shield which has an opening that becomes a passage of the X-ray which irradiates the affected part, wherein the front shield can adjust a region to be irradiated with the X-ray which irradiate the affected part. Specifically, the region to be irradiated with the X-ray can easily be adjusted by changing a diameter, a shape and a direction of the opening in the front shield. For this reason, the region to be irradiated with the X-ray can be set so as to have the optimal size and position according to the size and the position of the affected part, and thereby the affected part can be effectively and efficiently treated with X-ray.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-165360, filed Jul. 26, 2012, which is hereby incorporated by reference herein in its entirety.

What is claimed is:

1. An X-ray generating apparatus for paracentesis, which has an electron emitting portion arranged in an envelope, and a target that emits X-ray by irradiation with electrons that are emitted from the electron emitting portion, and irradiates a specific site with the X-ray which have been emitted from the target, comprising
a front shield which is arranged so as to protrude to the outside from the envelope, and has an opening that forms a passage of X-ray which irradiate the specific site, wherein the front shield can adjust a region to be irradiated with the X-ray on the specific site.

2. The apparatus according to claim 1, wherein
the specific site is an affected part in a living body.

3. The apparatus according to claim 1, wherein
the target is a transmission type target which constitutes a part of the envelope;
the front shield is provided so that the opening continues to the target;
a rear shield is arranged on the opposite side of the front shield to the target; and
the rear shield has an electron incidence hole which continues to the target and passes the electron therethrough.

4. The apparatus according to claim 1, wherein
the envelope and the front shield are detachably connected; and
the front shield can be exchanged with another front shield that has an opening of which the diameter, shape or direction is different, according to the region to be irradiated with the X-ray.

5. The apparatus according to claim 1, wherein
the front shield comprises an iris mechanism which can adjust an aperture diameter of the opening according to the region to be irradiated with the X-ray.

6. The apparatus according to claim 1, wherein
the front shield is provided so as to be rotatable around a rotation axis; and
the opening is provided so as to incline with respect to the rotation axis.

7. The apparatus according to claim 1, wherein
the front shield is arranged at one end side of the envelope; and
a grip portion is connected to the other end side of the envelope.

8. The apparatus according to claim 7, wherein
a through-hole in which a wire for supplying an electric power to the electron emitting portion passes is formed in an inner part of the grip portion.

9. The apparatus according to claim 7, wherein
the envelope is arranged in a storage container while having a space in a perimeter thereof;
a space is also formed in the inner part of the grip portion; and
the space between the storage container and the envelope formed in the inner part of the storage container and the space in the inner part of the grip portion communicate with each other and are filled with an insulating oil.

10. The apparatus according to claim 9, wherein
a mechanism for circulating the insulating oil is provided in the inner part of the grip portion.
